(19) United States
(12) Patent Application Publication
(10) Pub. No.: US 2026/0233364 A1
(43) Pub. Date: Aug. 13, 2026

(54) Magnetic sparkplug socket

(71) Applicant: Felipe Ferrer Monroe, Vacaville, CA (US)

(72) Inventor: Felipe Ferrer Monroe, Vacaville, CA (US)

(21) Appl. No.: 19/048,912

(22) Filed: Feb. 8, 2025

(51) Int. Cl. B25B 13/06; B25B 23/12

(52) U.S. Cl. CPC B25B 13/06; B25B 23/12

(57) ABSTRACT

The disclosure relates to a magnetic spark plug socket wrench that incorporates one or more magnetic members, which are embedded flush within the inner lower surface of the cylindrical body wall of the socket wrench. The magnetic members attract and prevent the spark plug from falling from the socket wrench into an automobile engine. The retention is accomplished when the magnetic members contact the spark plug placed within the socket wrench. The magnetic members are spaced equidistant and adhesively bonded flush within the cylindrical body to facilitate a strong magnetic attraction during installation or removal of the spark plug.

### FIELD OF INVENTION

The present invention relates to the field of hand tools and more particularly, to ratchet wrench socket attachments and the removal of spark plugs from an automobile engine.

### BACKGROUND

The repair and disassembly of an automobile engine involves the removal of nuts/bolts and spark plugs. Typically the tool of choice is the air impact or hand held ratchet wrench tool with socket wrench attachments. It has proven to be very challenging for most mechanics to service an automobile engine having difficult areas to access spark plugs. Sometimes positioning a tool up next to the spark plug proves nearly impossible due to the spark plug placement. It may be recessed into a tight compartment or blocked by an engine component. During removal, if the ratchet and socket wrench tool attachtment is tillted at an improper angle, the spark plug can fall out of the socket wrench into the automobile engine. As such, a need exists for a hand tool to facilitate the removal of spark plugs from these difficult areas. The present invention addresses this need.

### SUMMARY OF THE INVENTION

As discussed in the background information, it has proven to be very difficult for mechanics to install or remove spark plugs from hard to access areas when servicing an automobile engine. Part of the difficulty is that the spark plugs won't stay secure within the socket wrench during installation or removal. The present invention provides for easy retrieval and the retention of spark plugs. The magnetic socket wrench includes a cylindrical body that includes a central bore that extends the axial length of the body. The removal end includes an inner surface having at least one embedded magnet member for use in attracting and securing spark plugs within the socket wrench during the removal process.

### PROBLEMS WITH ORDINARY RATCHET WRENCH SOCKETS

The standard ratchet tool socket wrenches are used to install or remove multiple sizes and types of spark plugs primarily from machinery. Socket wrenches fit over spark plugs and a ratchet tool engages the socket wrench to allow the user to rotate the spark plug on or off the automobile engine.

The spark plug is held in place in the socket wrench by friction and leverage. During the installation or removal of a spark plug, if the socket wrench is worn or the angle of the ratchet and socket wrench held by the user is not proper, the spark plug can fall out of the socket wrench.

This design has limitations and creates the possibility of spark plugs falling into machinery and damaging equipment, or extending service time and repair cost of machinery.

### PROPOSED SOLUTIONS FOR ORDINARY RATCHET WRENCH SOCKETS

### Description of the Prior Art

Method 1. The most popular solution put forth in order to deal with this natural limitation inherent in the ordinary spark plug socket wrench design, has been the adaptation of crude methods of holding spark plugs in a socket. Most automobile mechanics will apply a heavy lube grease to the inner surface of the removal end of the spark plug socket wrench. The expectation is that the spark plug will stick in the lube grease within the socket during removal or installation. However there is no guarantee the spark plug will stay secure within the socket wrench. This method is hazardous, messy and requires cleanup afterwards.

Method 2. Another solution, and not nearly as popular, is to add a piece of plastic film to the inner surface of the removal end of the socket wrench. The plastic material will cause friction and hold the spark plug in the socket wrench. The issue with this method is the plastic material could fall into the automobile engine and wedge between an engine component. If the plastic material is not removed promptly it can cause a fire when the engine is put into service.

Method 3. The common design and industry solution for securing nuts/bolts or spark plugs within a socket wrench is to add rubber or foam material into the cylindrical body of the socket wrench to create suction. The rubber or foam material holds the spark plug with friction created by suction. However when the foam or rubber material cracks or hardens with age, it falls out of the socket wrench and can no longer hold the spark plug, making the removal process more difficult, and shortening the life-span of the tool.

Method 4. Another approach to addressing this problem was by adding a synthetic rubber cushioning, or plastic material embedded with magnets to the upper inside of the socket wrench. The problem with this design is the rubber or plastic material is a frictional fit and dependent on a coercive force between the magnet and metal socket. The placement of the rubber cushion or plastic material is too far into the cavity of the socket and creates a problem with the magnets reliably contacting and securely holding the nuts/bolts, or spark plugs.

It most be noted, that one of the most important requirements of a socket wrench is to hold a fastener or spark plug securely within the socket wrench, without it falling back into an automobile engine or other machinery. This system as put forth fails to recognize those demands.

Reference U.S. Pat. No. 2,551,553, U.S. Pat. No. 2,806,396, U.S. Pat. No. 5,259,278, U.S. Pat. No. 2,551,553

### The Objective

It is the object of this invention to provide a spark plug socket wrench that is more reliable than the conventional spark plug socket wrench. Most industry ratchet socket wrench sets include both metric and (S.A.E.) Society of Automotive Engineers standard sizes and shapes to fit a large variety of nuts/bolts, commonly referred to as fasteners. Fasteners are held within a socket wrench by friction and the angle of the socket wrench. If a socket wrench loses its friction due to the environment in which grease or oil are present, it can no longer hold a fastener securely in the socket wrench. The fastener will slip out of the socket wrench and could fall into machinery and cause catastrophic failure.

The goal of this invention is to design a ratchet socket wrench to prevent spark plugs from falling out of socket wrenches into machinery. To reduce the risk of spark plugs falling into automobile engines, causing damage and to safely remove or install spark plugs.

### The Solution

The present invention the magnetic socket wrench will use magnets to attract and hold automobile spark plugs during installation or removal. The socket wrench cylinder includes an inner surface having at least one embedded magnet member for use in attracting and securing the nuts/bolts or spark plugs within the socket wrench.

### BRIEF DESCRIPTION OF DRAWINGS

FIG. 1 is a perspective view of a spark plug ratchet socket wrench constructed and arranged in accordance with the principle of the invention;

FIG. 2 is the bottom view of the socket wrench cavity of FIG. I.

FIG. 3 is a top perspective view of the invention.

FIG. 4 shows a longitudinal half-sectional view of the present invention.

### DESCRIPTION OF THE PREFERRED EMBODIMENTS

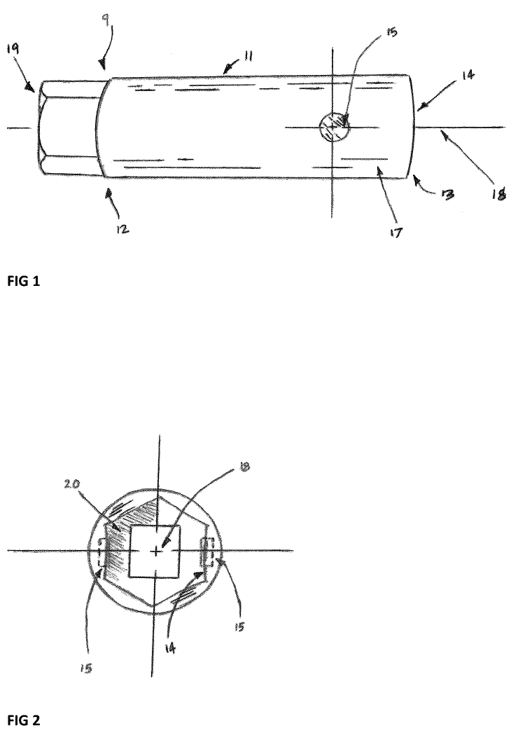

Turning now to the drawings, in which like reference characters indicate corresponding elements throughout the several views, attention is first directed to FIGS. 1-4 in which there is seen a spark plug socket wrench 9. The socket wrench is preferably formed of metal, or other chosen material or combination of materials having inherently rigid, resilient, and fluid-impervious material characteristics and shaped as a cylinder 11, consisting of two parallel circular bases 12 and 13, joined by a curved surface. Inner surface 14 having a magnetic material 15 embedded, in the lower edge 17, or any preferable area of the cylinder 11. The inner surface 14 is generally a “hexagonal” configuration in this example, and can be provided in other chosen shapes, such as “twelve point”, or any other chosen shape or size to fit all metric and (S.A.E.) size spark plugs to attain the desired objective.

Referring to FIG. 1 spark plug socket wrench 9 additionally includes a longer cylindrical body length specifically longer than a standard nuts/bolts socket wrench, and is intended for the removal or installation of spark plugs for an automobile engine. As will be described, the magnetic material 15 cooperates with inner surface 14 of cylinder 11 to form or otherwise establish a receiver area 14 to enable the capture and easy removal of spark plugs. The upper edge 19 engages with a ratchet tool ¼ inch, or ⅜ inch square drive to facilitate the removal of spark plugs. As shown in FIGS. 1 and 2, the spark plug socket wrench cylindrical body 11 further includes a central bore 18 that extends the axial length of the body 11.

FIG. 2 shows the spark plug socket wrench viewed from the bottom end 17, containing a cavity 20 for receiving fasteners such as nuts/bolts or spark plugs for installation or removal from machinery. For example spark plug socket wrench 9 inner surface 14 fits over metric and (S.A.E.) size nuts or bolts. The upper edge 19 square bore engages with a ratchet tool ¼ inch, or ⅜ inch square drive to facilitate the removal of spark plugs or nuts/bolts by the user. The inner surface 14 is generally a “hexagonal” configuration in this example, and can be provided in other chosen shapes, such as “twelve point”, or any other chosen shape, size or length to fit all metric and (S.A.E.) size nuts/bolts or spark plugs to attain the desired objective.

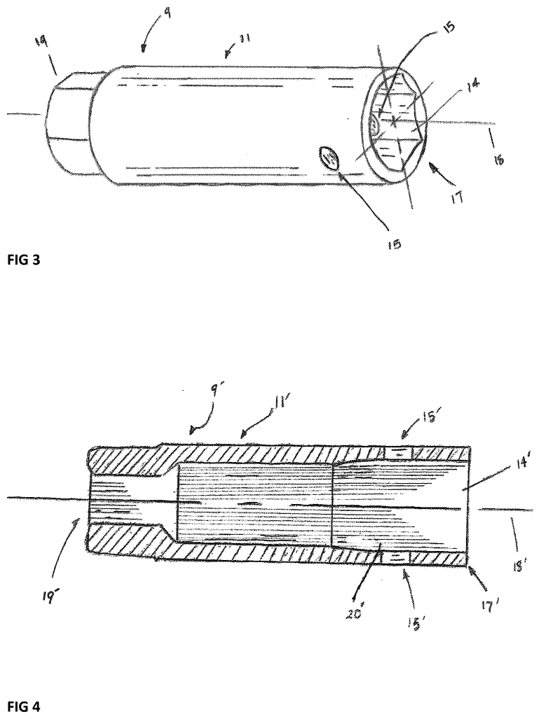

Attention is now directed to FIG. 3, in which there is seen an alternate embodiment from a perspective view of the spark plug socket wrench. In common with a non-magnetic socket wrench, spark plug socket wrench 9 shares a cylinder shape 11, a central bore 18 that extends the axial length of the body, a inner surface 14 and has at least one or two embedded magnetic members 15 thereon, that is preferably a substanially cylindrical shape which facilitates a magnetic attraction and securing the capture of nuts/bolts or automobile engine spark plugs.

In accordance with the present invention, at least one magnet member 15 may be any suitable magnet having a sufficient strength for holding nuts/bolts or automobile spark plugs. It is possible different strength magnets could be used for different applications. Specific types of magnets are well known to the person of ordinary skill in the art. At least one magnet 15 is preferably secured to the inner surface 14 by an adhesive.

The magnets 15 used for the spark plug socket wrench are cylindrical magnets inserted equidistant from one another in the removal end and lower edge 17. The magnets 15 are flush with the inner surface 14 so that nuts/bolts or spark plugs can fit within the socket wrench and be secured.

To summarize the main features of the magnetic socket wrench, one end of the socket wrench includes an axial cavity and at least one embedded magnet that is sized for fitting in the inner surface of the lower edge, to facilitate the nuts/bolts or spark plug attraction at the removal end of the socket wrench. The axial cavity is sized in accordance with varying metric and (S.A.E.) sizes so in application it allows the embedded magnet to receive and hold nuts/bolts and spark plugs of various sizes. The other end of the spark plug socket wrench utilizes a square bore, ¼ inch, or ⅜ inch that attaches to a ratchet wrench tool, with or without extention to use in the application of nuts/bolts or spark plug removal as described in this specification.

The spark plug socket wrench body is preferably made from metal, or other material or combintion of materials having inherently rigid, resilient, and fluid-impervious strong material characteristics known in the art to carry out the described objectives.

As mentioned above, the current invention addresses the problems associated with accessing and safely securing spark plugs for removal when performing service on an automobile engine. The utility of the present invention is directed to metric or (S.A.E.) socket wrench tool attachments for enabling the easy removal of spark plugs.

Use of the spark plug socket wrench attachment as shown in the drawings is as follows: The user attaches the socket upper edge 19 to the drive of a air impact tool, or ratchet wrench tool and places the socket wrench lower edge 17 over the nuts/bolts or spark plugs, so that it is received within the axial cavity 20, and the magnetic members 15 are in contact with the nuts/bolts or spark plugs. The magnetic force of attraction from the magnetic members 15 will hold the nuts/bolts or spark plugs, as the socket wrench is upwardly withdrawn from the automobile engine. The user can then safely remove the nuts/bolts or spark plugs from the socket wrench by hand. The time of removal typically taking less than a few minutes to perform.

The spark plug socket wrench will be available in different diameters to accommodate all popular metric and (S.A.E.) size spark plugs. As previously described the inner surface having at least one magnet member 15′ thereon, is preferably a substantially configuration that defines an attraction surface for securing the easy removal and retention of spark plugs from an automobile engine.

At least one magnet 15′ is preferably secured to the inner surface 14′ by an adhesive. The magnets 15′ used for the spark plug socket wrench are cylindrical magnets inserted equidistant from one another in the removal end and lower edge 17′. The magnets 15′ are flush with the inner surface 14′ so that nuts/bolts or spark plugs can fit within the socket and be retained. The upper end 19′ of the spark plug socket wrench utilizes a square bore, ¼ inch, or ⅜ inch that attaches to a air impact tool or ratchet wrench tool, with or without extention to use in the application of nuts/bolts or spark plug removal as described in this specification.

While the instant invention has been shown and described herein in what are conceived to be the most practical and preferred embodiments, it is recognized that departures may be made therefrom within the scope of the invention, which is therefore not to be limited to the details disclosed herein, but is to be afforded the full scope of the claims so as to embrace any and all equivalent compositions and methods. For example, the application given described the present socket attachment primarily for being used to remove nuts/bolts or spark plugs from an automobile engine. However, it should be understood from the description given that the socket attachment can be used for removing nuts/bolts and the like in other applications such as, but not limited to, an automobile engine.

As such, it will be obvious to those skilled in the art that modifications may be made to the embodiments described above without departing from the scope of the invention. Thus the scope of the invention should be determined by the claims in the formal application and their legal equivalents, rather than by the examples given.

What is claimed is:

1. A magnetic spark plug socket which comprises:
a cylindrical body having a first end dimensioned and configured for cooperation with an associated ratchet wrench tool and a second end dimensioned and hexagonal configured for engagement with automobile engine spark plugs, said second end including one or more embedded magnets disposed to retain a spark plug within said second end, for a meshing engagement with the spark plug, whereby rotation of the socket causes rotation of the spark plug.

2. The socket as described in claim 1 wherein each of said magnets is axially equidistant and has a geometric axis.

3. The socket as described in claim 1 wherein the axis of each magnet is parallel to every other axis of every other magnet in said socket.

4. The socket as described in claim 1 wherein each of said magnets is cylindrical.

5. The socket described in claim 1 wherein each of said magnets is axially magnetized.

6. The socket as described in claim 1 wherein each magnet is parallel to every other magnet and each has a north and a south pole and the physical orientation each north and south pole is identical.

7. The socket as described in claim 1 wherein each of said magnets is
manufactured of neodymium and adhesively bonded flush within the cylindrical body of the socket wall.
